(19) United States
(12) Patent Application Publication
(10) Pub. No.: US 2007/0049720 A1
(43) Pub. Date: Mar. 1, 2007

(54) Polyurethanes, their preparation and use

(75) Inventors: Jens Krause, Koln (DE); James-Michael Barnes, Breitscheid (DE); Harald Knaup, Neuss (DE); Hartmut Nefzger, Pulheim (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/508,071

(22) Filed: Aug. 22, 2006

(30) Foreign Application Priority Data
Aug. 26, 2005 (DE) 102005040465.0

(51) Int. Cl. C08G 18/00

(52) U.S. Cl. 528/44

(57) ABSTRACT

Polyurethanes are produced using 2,2′-thiodiethanol as the chain lengthener. These polyurethanes are useful for the production of cast elastomers.

### BACKGROUND OF THE INVENTION

The present invention relates to a process for the preparation of the polyurethanes using 2,2′-thiodiethanol as a chain lengthener and to the polyurethanes produced by this process.

Cast polyurethane (PU) elastomers are valuable materials and are prepared from polyisocyanates, polyols and chain lengtheners and/or crosslinking agents. Industrially important polyisocyanates useful for producing such elastomers include those which originate from the diphenylmethane family (MDI), toluene-based (TDI) and those which are built up from 1,5-naphthylene-diisocyanate (NDI).

Suitable polyols for the production of such elastomers include the polyester polyols and/or polyether polyols which are known to the person skilled in the art and usually have hydroxyl end groups. Short-chain polyols such as ethylene glycol or 1,4-butylene glycol, short-chain polyamines such as 4,4′-methylene-bis(2-chloroaniline) (MBOCA) and also water are often employed as chain lengtheners.

In the preparation of PU cast elastomers, a distinction is made between the one-shot process, in which the reaction components polyisocyanate, polyol and chain lengthener are reacted simultaneously with one another, and the prepolymer process, in which the polyol is reacted with the polyisocyanate and only then is the chain-lengthening component employed.

Auxiliary substances and additives, such as catalysts, reaction retarders, oxidation, microbe and UV stabilizers as well as flameproofing agents, antistatics, blowing agents and fillers, can of course be employed in the preparation of the elastomers.

In the reaction to build up the molecular weight of the elastomer, the chain lengthener and polyisocyanate form the hard segment domains. For high-performance elastomers, such as, for example, 1,5-NDI-based elastomers (e.g. Vulkollan®, product group of Bayer MaterialScience AG) or thermoplastic polyurethanes (TPU) (such as, for example, Desmopan®, product group of Bayer MaterialScience AG) or cellular elastomers, for example 1,5-NDI-based elastomers (e.g. cellular Vulkollan®, product group of Bayer MaterialScience AG, or Cellasto®, product group of Elastogran GmbH), 1,4-butanediol has proven itself in particular as an inexpensive and suitable crosslinking agent.

The prepolymer process is preferably employed for the preparation of PU elastomers. 1,4-butanediol is a chain lengthener/crosslinking agent which is employed in very many cases. Nevertheless, 1,4-butanediol has a very high or too high a reactivity for hard PU elastomers (such as 1,5-NDI elastomers 40-100), i.e. the casting times are too short, so that these PU types cure too rapidly and therefore are scarcely processable. The number after the 1,5-NDI elastomer denotes the amount of 1,5-NDI per 100 parts by wt. of polyol. 2,3-Butanediol has therefore been employed as a crosslinking agent for hard elastomer types, which renders possible longer casting times compared with 1,4-butanediol, as a result of its chemical structure. Nevertheless, disadvantages of 2,3-butanediol are its limited availability and high price.

For softer PU elastomers (such as 1,5-NDI elastomers 18-30), which require longer casting times than are possible with 1,4-butanediol (e.g., in the production of complicated moldings), 1,4-butanediol to which acid has been added can also be employed in industrial practice. However, the high corrosiveness of PU prepared in such a manner is a disadvantage here. Furthermore, the stability towards hydrolysis, in particular of polyester-based types, is adversely influenced.

### SUMMARY OF THE INVENTION

The object of the present invention was therefore to provide a process or a chain-lengthening agent which allows longer casting time to be achieved in the reaction of PU-NCO prepolymers with crosslinking agents, where the mechanical properties of the PU elastomers prepared in this way should not be poorer than those of comparable elastomers of the prior art.

It has been found, surprisingly, that if 2,2′-thiodiethanol is used as a chain lengthener, PU elastomers having good mechanical properties can be prepared, and that the casting times can be prolonged, so that it is now possible also to produce complicated moldings from hard PU elastomers.

### DETAILED DESCRIPTION OF THE INVENTION

The present invention provides polyurethanes and a process for the production of such polyurethanes in which
a) an NCO prepolymer based on at least one of the following polyisocyanates: p-phenylene-diisocyanate (PPDI), 1,5-naphthalene-diisocyanate (1,5-NDI), 3,3′-dimethyl-4,4′-biphenyl-diisocyanate (TODI), 1,4-cyclohexane-diisocyanate (CHDI), 1,6-hexamethylene-diisocyanate (HDI), methyldicyclohexyl-diisocyanate (H12-MDI) and the modified compounds of these isocyanates in the form of allophanates, biurets and carbodiimides, as well as dimers and trimers of these isocyanates is reacted with
b) 2,2′-thiodiethanol as a chain lengthener and
c) optionally, with the addition of catalysts, blowing agents and additives and auxiliary substances.

2,2′-Thiodiethanol can of course also be employed in a mixture with one or more other hydroxyl group-containing materials or polyols.

Suitable hydroxyl group-containing materials and polyols for mixing with 2,2′-thiodiethanol include other chain lengtheners such as: propane-1,2-diol, propane-1,3-diol, glycerol, butane-2,3-diol, butane-1,3-diol, butane-1,4-diol, 2-methylpropane-1,3-diol, pentane-1,2-diol, pentane-1,3-diol, pentane-1,4-diol, pentane-1,5-diol, 2,2-dimethyl-propane-1,3-diol, 2-methylbutane-1,4-diol, 2-methylbutane-1,3-diol, 1,1,1-trimethylolethane, 3-methyl-1,5-pentanediol, 1,1,1-trimethylolpropane, 1,6-hexanediol, 1,7-heptanediol, 2-ethyl-1,6-hexanediol, 1,8-octanediol, 1,9-nonanediol, 1,10-decanediol, 1,11-undecanediol, 1,12-dodecanediol, diethylene glycol, triethylene glycol, 1,4-cyclohexanediol, 1,3-cyclohexanediol and water.

Materials useful as builder components for the prepolymers employed in the process of the present invention include polyols having number-average molecular weights of from 600 g/mol to 20,000 g/mol and polyisocyanates having an NCO content of from 3 to 51 wt. % which are known to the person-skilled in the art.

The polyols can be polyester polyols, polycarbonate polyols or polyether polyols or mixtures thereof.

Preferably, 1,5-NDI, TODI and PPDI are used as the polyisocyanate component, most preferably 1,5-NDI.

The polyurethanes prepared according to the invention using 2,2′-thiodiethanol as a chain lengthener include cellular and solid PU cast elastomers.

Surface defects which may occur (e.g., bubble formation) can be prevented by the addition of silicone stabilizers (e.g., polyether-siloxanes, which can be obtained e.g., from Tego GmbH) in amounts of up to 10 wt. %, more preferably up to 2 wt. %, based on the polyurethane.

The catalysts, blowing agents and auxiliary substances and additives known from polyurethane chemistry can also be employed in the process of the present invention. (See, inter alia, Kunststoffhandbuch, Polyurethan, volume 7; in particular chapter 3.4).

The invention is explained in more detail with the aid of the following examples.

### EXAMPLES

The comparison examples were prepared using 2,3-butanediol and the examples according to the invention were prepared using 2,2′-thiodiethanol. The precise compositions are to be found in Table 1.

TABLE 1
Recipes and properties of the polyurethanes

| | | | Example | | | | | |
|---|---|---|---|---|---|---|---|---|
| | | DIN | 1 | 2 | 3 | 4* | 5* | 6* |
| Polyol 1 | [pbw]¹ | | 100 | 100 | 100 | | | |
| Polyol 2 | [pbw]¹ | | | | | 100 | 100 | 100 |
| Crosslinking agent | [pbw]¹ | | 1.0 | 3.00 | 4.00 | 1.0 | 3.00 | 4.00 |
| Isocyanate | [pbw]¹ | | 40 | 50 | 60 | 40 | 50 | 60 |
| 2,3-Butanediol | [pbw]¹ | | | | | 10 | 12 | 15 |
| 2,2′-Thiodiethanol | [pbw]¹ | | 13.7 | 16.4 | 20.5 | | | |
| Characteristic | | | 40 | 50 | 60 | 40 | 50 | 60 |
| number | | | | | | | | |
| Properties | | | | | | | | |
| Casting time | [s] | | 240 | 270 | 240 | 150 | 120 | 90 |
| Hardness | [Shore A] | 53505 | 99 | 100 | 100 | 96 | 98 | 98 |
| Hardness | [Shore D] | 53505 | 54 | 52 | 59 | 48 | 56 | 62 |
| Stress/strain | [MPa] | 53504 | 12.3 | 14.9 | 18.8 | 12 | n.d. | 19 |
| modulus | | | | | | | | |
| 100% | | | | | | | | |
| Stress/strain | [MPa] | 53504 | 17.1 | 22.0 | 24.6 | 18 | n.d. | 30 |
| modulus | | | | | | | | |
| 300% | | | | | | | | |
| CS (70 h, 23° C.) | [%] | 53517 | 16.2 | 20.4 | 27.4 | 26 | n.d. | 41 |
| CS (24 h, 70° C.) | [%] | 53517 | 24.0 | 26.2 | 30.3 | 45 | n.d. | 75 |
| Yield stress | [MPa] | 53504 | 40.2 | 36.0 | 36.3 | 32 | n.d. | 33 |
| Rebound resilience | [%] | 53512 | 50 | 43 | 43 | 40 | n.d. | 35 |

*Comparison
¹pbw = parts by weight
n.d. = not determined
Polyol 1: Desmophen ® 2010 I (product of Bayer MaterialScience AG, polyester polyol based on ethylene glycol, butanediol and adipic acid; molecular weight 2,000, functionality 2)
Polyol 2: Desmophen ® 2000 MM (product of Bayer MaterialScience AG, polyester polyol based on ethylene glycol and adipic acid; molecular weight 2,000, functionality 2)
Crosslinking agent: 1,1,1-Trimethylolpropane (Vernetzer TR, product of Rheinchemie)
Isocyanate: 1,5-NDI; Desmodur ® 15 (product of Bayer MaterialScience AG)
CS: Compression set

The OH number of the 2,2′-thiodiethanol used was 910 mg KOH/g, 2,3-butanediol had an OH number of 1,245 mg KOH/g.

Table 1 shows that the cast elastomers Examples 1 to 3 according to the invention have casting times which are lengthened compared with the cast elastomers of Examples 4 to 6, which are not according to the invention.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A polyurethane which is the reaction product of
a) an NCO-terminated prepolymer of a polyisocyanate selected from the group consisting of: p-phenylene-diisocyanate (PPDI); 1,5-naphthalene-diisocyanate (1,5-NDI); 3,3′-dimethyl-4,4′-biphenyl-diisocyanate (TODI); 1,4-cyclohexane-diisocyanate (CHDI); 1,6-hexamethylene-diisocyanate (HDI); methyldicyclohexyl-diisocyanate (H12-MDI); allophanates of PPDI, 1,5-NDI, TODI, CHDI, HDI, and H12-MDI; biurets of PPDI, 1,5-NDI, TODI, CHDI, HDI, and H12-MDI; carbodiimides of PPDI, NDI, TODI, CHDI, HDI, and H12-MDI; dimers of PPDI, 1,5-NDI, TODI, CHDI, HDI and H12-MDI; and trimers of PPDI, 1,5-NDI, TODI, CHDI, HDI and H12-MDI with
b) 2,2′-thiodiethanol as a chain lengthener and
c) optionally, with a catalyst, blowing agent, additive or auxiliary substance.

2. The polyurethane of claim 1 in which the NCO-terminated prepolymer is a prepolymer of 1,5-naphthalene-diisocyanate.

3. The polyurethane of claim 1 in which the NCO-terminated prepolymer is produced with a polyol having a number-average molecular weight of from 600 g/mol to 20,000 g/mol.

4. The polyurethane of claim 3 in which the polyol is a polyester polyol, a polycarbonate polyol, a polyether polyol or a mixture thereof.

5. The polyurethane of claim 1 in which the 2,2′-thiodiethanol is used in combination with at least one chain lengthener selected from the group consisting of: propane-1,2-diol, propane-1,3-diol, glycerol, butane-2,3-diol, butane-1,3-diol, butane-1,4-diol, 2-methylpropane-1,3-diol, pentane-1,2-diol, pentane-1,3-diol, pentane-1,4-diol, pentane-1,5-diol, 2,2-dimethyl-propane-1,3-diol, 2-methylbutane-1,4-diol, 2-methylbutane-1,3-diol, 1,1,1-trimethylolethane, 3-methyl-1,5-pentanediol, 1,1,1-trimethylolpropane, 1,6-hexanediol, 1,7-heptanediol, 2-ethyl-1,6-hexanediol, 1,8-octanediol, 1,9-nonanediol, 1,10-decanediol, 1,11-undecanediol, 1,12-dodecanediol, diethylene glycol, triethylene glycol, 1,4-cyclohexanediol, 1,3-cyclohexanediol and water.

6. The polyurethane of claim 1 in which a silicone stabilizer included in an amount of from >0 to 10 wt. %, based on total weight of the polyurethane.

7. The polyurethane of claim 6 in the silicone stabilizer is a polyether-siloxane.

8. A process for the production of a polyurethane comprising reacting
A) an NCO-terminated prepolymers of a polyisocyanate selected from the group consisting of: p-phenylene-diisocyanate (PPDI); 1,5-naphthalene-diisocyanate (1,5-NDI); 3,3′-dimethyl-4,4′-biphenyl-diisocyanate (TODI); 1,4-cyclohexane-diisocyanate (CHDI); 1,6-hexamethylene-diisocyanate (HDI); methyldicyclohexyl-diisocyanate (H12-MDI); allophanates of PPDI, 1,5-NDI, TODI, CHDI, HDI, and H12-MDI; biurets of PPDI, 1,5-NDI, TODI, CHDI, HDI, and H12-MDI; carbodiimides of PPDI, 1,5-NDI, TODI, CHDI, HDI, and H12-MDI; dimers of PPDI, 1,5-NDI, TODI, CHDI, HDI and H12-MDI; and trimers of PPDI, 1,5-NDI, TODI, CHDI, HDI and H12-MDI with
B) 2,2′-thiodiethanol as a chain lengthener and
C) optionally, a catalyst, blowing agent, additive or auxiliary substance.

9. The process of claim 8 in which the NCO-terminated prepolymer is a prepolymer of 1,5-naphthalene-diisocyanate.

10. The process of claim 8 in which the NCO-terminated prepolymer is produced with a polyol having a number-average molecular weight of from 600 g/mol to 20,000 g/mol.

11. The process of claim 10 in which the polyol is a polyester polyol, polycarbonate polyol, polyether polyol or mixture thereof.

12. The process of claim 8 in which the 2,2′-thiodiethanol is used in combination with at least one chain lengthener selected from the group consisting of: propane-1,2-diol, propane-1,3-diol, glycerol, butane-2,3-diol, butane-1,3-diol, butane-1,4-diol, 2-methylpropane-1,3-diol, pentane-1,2-diol, pentane-1,3-diol, pentane-1,4-diol, pentane-1,5-diol, 2,2-dimethyl-propane-1,3-diol, 2-methylbutane-1,4-diol, 2-methylbutane- 1,3-diol, 1,1,1-trimethylolethane, 3-methyl-1,5-pentanediol, 1,1,1-trimethylolpropane, 1,6-hexanediol, 1,7-heptanediol, 2-ethyl-1,6-hexanediol, 1,8-octanediol, 1,9-nonanediol, 1,10-decanediol, 1,11-unde-canediol, 1,12-dodecanediol, diethylene glycol, triethylene glycol, 1,4-cyclohexanediol, 1,3-cyclohexanediol and water.

13. The process of claim 8 in which a silicone stabilizer is used in an amount of from >0 to 10 wt. %, based on total weight of the polyurethane.

14. The process of claim 8 in which a silicone stabilizer is used in an amount of from >0 to 2 wt. %, based on total weight of the polyurethane.

15. The process of claim 13 in which the silicone stabilizer is a polyether-siloxane.

16. A cast elastomer produced from the polyurethane of claim 1.
